(19) United States
(12) Patent Application Publication
(10) Pub. No.: US 2026/0370363 A1
(43) Pub. Date: Nov. 19, 2026

(54) AUTOMATIC NETWORK SELECTION FOR MOBILE DEVICES

(71) Applicant: T-Mobile USA, Inc., Bellevue, WA (US)

(72) Inventors: Puja Gupta, Redmond, WA (US); Mehmet Hinc, Snoqualmie, WA (US)

(21) Appl. No.: 19/210,473

(22) Filed: May 16, 2025

(51) Int. Cl. H04B 17/373; H04L 41/16; H04W 24/08; H04W 76/15

(52) U.S. Cl. CPC H04B 17/373; H04L 41/16; H04W 24/08; H04W 76/15

(57) ABSTRACT

Systems, methods, and computer-readable media are disclosed herein for the automatic connection of a mobile device to a network providing improved signal quality relative to a first network. A communication link between the mobile device and the first network is monitored at a predetermined time interval, and a determination is made, based on the monitoring that the communication link does not meet a predetermined quality threshold. A second network having a predicted signal quality exceeding the signal quality associated with the first communication link is selected using an AI model. A second communication link between the mobile device and the second network is established.

### BACKGROUND

A telecommunications network is established via a complex arrangement and configuration of many cell sites that are deployed across a geographic area. For example, there can be different types of cell sites (e.g., macro cells, microcells, and so on) positioned in a specific geographical location, such as a city, neighborhood, and so on. These cell sites strive to provide adequate, reliable coverage for mobile devices (e.g., smart phones, tablets, and so on) via different frequency bands and radio networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long-Term Evolution (LTE) network, 5G mobile communications network, IEEE 802.11 (WiFi), or other communications networks. The devices can seek access to the telecommunications network for various services provided by the network, such as services that facilitate the transmission of data over the network and/or provide content to the devices.

A telecommunications network can be a terrestrial network (TN) or non-terrestrial network (NTN). TNs rely on Earth-bound infrastructure, including cell towers and fiber cables, while NTNs utilize various types of satellites (geostationary equatorial orbit, Medium-Earth orbit, and Low-Earth orbit) or other aerial devices for increased coverage.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is an illustration of an example network selection environment, in accordance with some implementations of the present technology.

FIG. 4 is a block diagram illustrating example components of the network selection module, in accordance with some implementations of the present technology.

FIG. 5 is a method flowchart illustrating an example method of establishing a communication link between a mobile device and a network, in accordance with some implementations of the present technology.

FIG. 6 is a block diagram that illustrates an example of an artificial intelligence system in which at least some operations described herein can be implemented.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

As the number and types of telecommunications networks continue to grow, it has become increasing difficult to identify which network a mobile device should connect to when an initial network connection fails, the mobile device moves to a geographical location where the initial network connection is no longer available, and/or the signal quality of a network connection otherwise decreases below an acceptable threshold. Many existing mobile devices do not have a means of automatically detecting that signal quality has fallen below a desired quality threshold and selecting a new network for the mobile device to connect to. Where such network selection technologies do exist, these technologies are often limited to selecting between terrestrial networks and/or are limited to connecting to a new network based on manual selection of that network. Additionally, existing network selection technologies are limited in their ability to predict the quality of a network's signal based on a number of dynamically changing factors.

Systems, methods, and computer-readable media are disclosed herein for the automatic connection of a mobile device to a network providing improved signal quality relative to a first network. The present technology improves on existing network selection solutions by monitoring the network connection between a mobile device and a first network at regular time intervals, enabling deficiencies in signal quality to be automatically detected. The duration between monitoring actions can be determined based on various conditions associated with the mobile device and/or the network connection, enabling the frequency of monitoring to be increased when needed to maintain a reliable connection and decreased when computational and battery resources can be conserved. When deficiencies in signal quality are detected, an artificial intelligence (AI) model stored on the mobile device is used to select a second network with a predicted signal quality that exceeds the signal quality of the first network, and a connection to the second network is established. Thus, the mobile device is automatically connected to a network providing a higher quality network connection without the need for manual selection of the network. Furthermore, the AI model can account for a variety of dynamically changing factors when making a signal quality prediction, including for both terrestrial and non-terrestrial networks (NTNs). For example, the AI model can evaluate a satellite rotation schedule and/or a number of satellites for an NTN to predict the network's signal quality and connect to that non-terrestrial network when doing so is a desirable alternative to a terrestrial connection.

The benefits of the present technology include improved network performance, enhanced user experience, and more efficient use of network and device resources. The ability to seamlessly switch between terrestrial and non-terrestrial networks, which is typically not offered by existing solutions, expands connectivity options, particularly in areas with limited terrestrial coverage.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

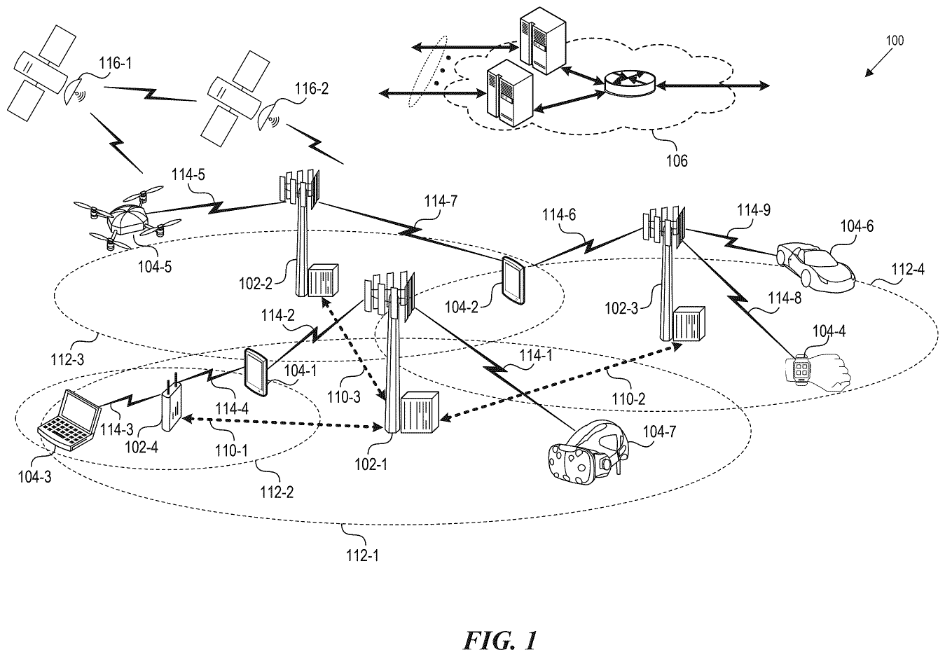

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station as compared to a macro cell and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100, including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

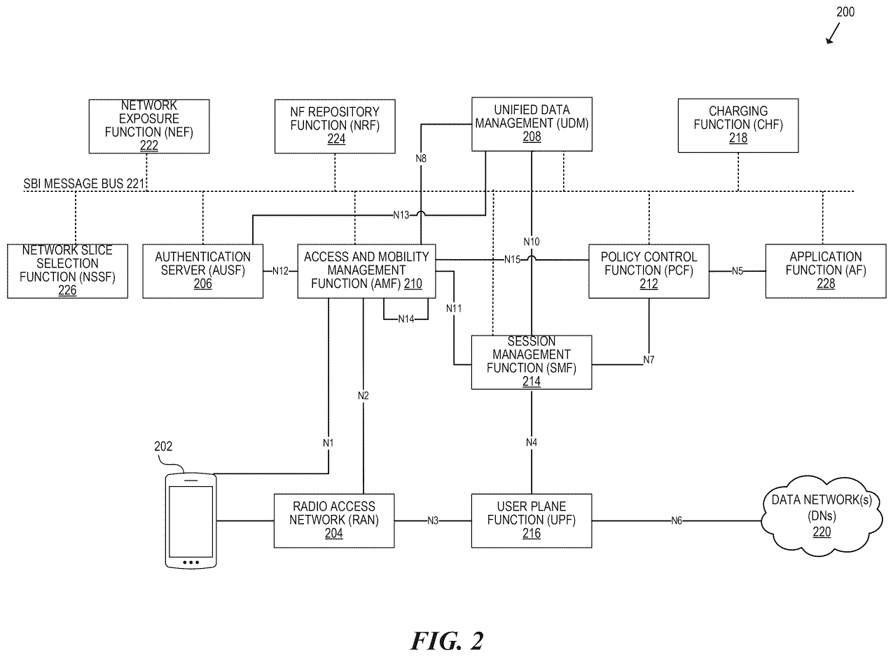

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Network Selection Environment

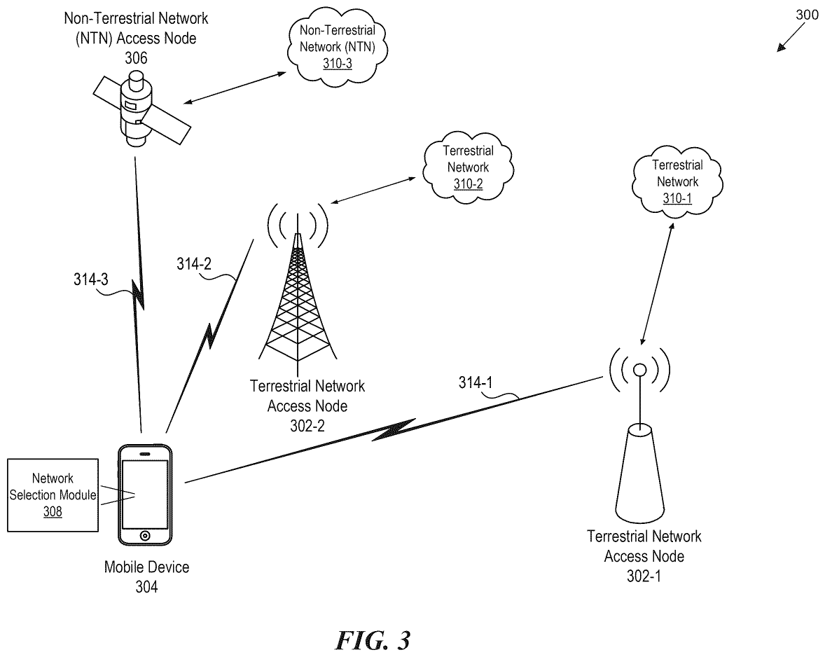

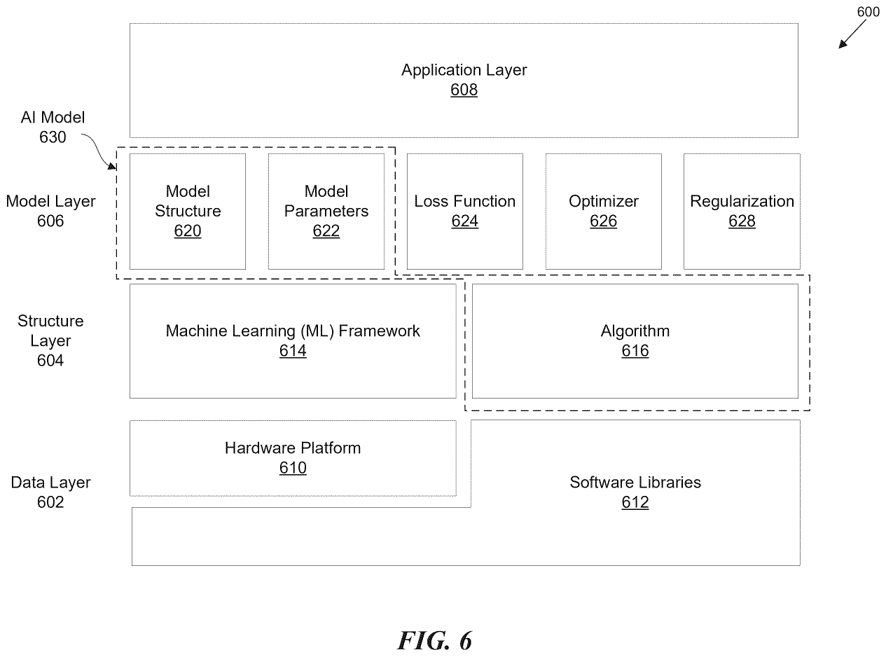

FIG. 3 is an illustration of an example network selection environment 300, in accordance with some implementations of the present technology. The network selection environment 300 includes multiple terrestrial network access nodes 302-1, 302-2, a mobile device 304, a non-terrestrial network (NTN) access node 306, a network selection module 308, multiple terrestrial networks 310-1, 310-2, and an NTN 310-3. The network selection module 308 can be implemented using components of the example computer system illustrated and described in more detail with reference to FIG. 6. Likewise, implementations of the example network selection environment 300 can include different and/or additional components or can be connected in different ways.

The terrestrial access nodes 302-1 and 302-2 are base stations which each connect to different terrestrial networks 310-1 and 310-2, which use exclusively Earth-based access nodes (e.g., stationary access nodes physically located on Earth). Each terrestrial network 310-1, 310-2 is provided by a different wireless network provider. The NTN access node 306 is a base station which connects to the NTN 310-3, which exclusively uses airborne NANs such as satellites. In some implementations, the NTN 310-3 is provided by a different network provider than either of the terrestrial networks 310-1, 310-2.

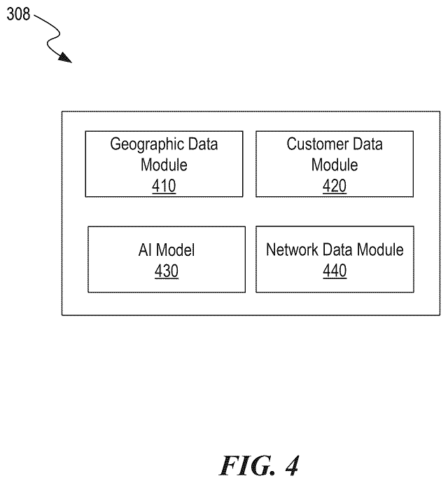

The mobile device 304 is a mobile wireless device capable of connecting to a network, such as the mobile devices 104-1 and 104-2 described in relation to FIG. 1 above. The mobile device 304 includes a network selection module 308, which is a software component stored on a memory of the mobile device. The network selection module 308 is configured to select a network 310 for which a communication link 314 between the mobile device 304 and that network 310 will be established. Communication links 314 are streams of one or more signals transmitted between the mobile device 304 and a NAN for a network 310 (e.g., the terrestrial network access nodes 302-1, 302-2, the NTN access node 306). In some implementations, the communication links 314 are the same as or generally similar to the communication links 114 described in relation to FIG. 1 above. In some implementations, the network selection module 308 includes and/or is communicatively coupled to an AI model (e.g., as described in relation to FIGS. 4-6 below) trained to output a predicted signal quality of a network. The predicted signal quality can be a representation of a predicted quality of a communication link 314 between the mobile device 304 and a network 310, where quality includes factors associated with the reliability of transmitting the communication link 314, such as speed of data transmission, availability of signal of the network 310, strength of/geographic area covered by the signal of the network 310, and the like. In these and other implementations, the network selection module 308 may establish the communication link 314 using the method 500 described in relation to FIG. 4 below.

FIG. 3 and the discussion herein provide a brief, general description of a suitable network selection environment 300 in which the network selection module 308 can be supported and implemented. Although not required, aspects of the network selection module 308 may include computer-executable instructions, such as routines executed by a computer, e.g., mobile device, a server computer, or personal computer. The system can be practiced with other communications, data processing, or computer system configurations, including: Internet appliances, handheld devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor. Further details regarding the operation and implementation of the network selection module 308 will now be described.

### Example Network Selection Module

FIG. 4 is a block diagram illustrating example components of the network selection module 308, in accordance with some implementations of the present technology. network selection module 308 can include functional modules that are implemented with a combination of software (e.g., executable instructions, or computer code) and hardware (e.g., at least a memory and processor). Accordingly, as used herein, a module can be a processor-implemented module or set of code and can represent a computing device having a processor that is at least temporarily configured and/or programmed by executable instructions stored in memory to perform one or more of the specific functions described herein. For example, the network selection module 308 can include a geographic data module 410, a customer data module 420, an AI model 430, and a network data module 440, each of which is discussed separately below.

### Geographic Data Module

The geographic data module 410 is configured and/or programmed to receive geographic data. For example, the geographic data module 410 collects/receives/accesses maps of geographic areas, geographic coordinates of particular locations, geographic coordinates of a mobile device, and/or other geographic information from a global navigation satellite system (GNSS) or other source of geographic data. The geographic data module 410 can collect/receive/access geographic data from one or more sources, such as third-party applications (e.g., OpenStreetMaps, Google® Maps, Waze®, Here WeGo®, Inrix, MapQuest, TomTom etc.) via, for example, Application Programming Interfaces (APIs).

### Customer Data Module

The customer data module 420 is configured and/or programmed to receive a customer's data when accessing services/utilities associated with a telecommunications network. For example, the customer data module 420 collects/receives/accesses one or more of the following customer data records associated with a customer relating to the following types of information (which can be stored in a memory of a mobile device including the network selection module 308): location specific records (LSR), call data records (CDRs), timing advance values, RF signal data, speed, experience throughputs, reported coverage, distance between the customer and at least one telecommunications network site, strength of signal, quantity of data used, type of device of the customer, applications data (e.g., application type, name, owner, manager, data sent/received/used/saved, bandwidth used, APIs accessed, etc.), source of customer records (for example, telecommunications service provider, third-party, application owner, etc.). Examples of other types of data collected by the customer data module 420 include, but are not limited to, data collected from third-party applications (e.g., including crowdsourced data) that can help to determine customer experience with location. For example, the customer data module can collect information of a user's location using his/her social media posts. As another example, the customer data module collects application level data (e.g., collected using applications related to Internet of Things (IoT) devices, sensors, billing meters, traffic lights, etc.) to identify the user location and applications used to enhance the location algorithm.

The customer data records associated with the customer can comprise information about an associated customer location and an associated timestamp. For example, a call data record for a customer can identify a customer location and a timestamp when the call was initiated. As another example, customer data records can include a subscription level of a customer representing the particular subscription to a network that the customer has purchased from a network provider, including information regarding data roaming agreements defining other networks the customer can connect to and the associated costs of connecting. The customer data module 420 can collect customer data records that span a particular period of time depending on, for example, density of customer records, customer activity, types of customer records (for example, text, voice, video, app-usage, emergency services, etc.), services/products to be offered to the customer, types of customer experience enhancement solutions/actions to be implemented, source of customer records, and so on.

### AI Model

The AI model 430 is executed by the network selection module 308 and can include some or all of the features described in relation to the AI model 630 of FIG. 6. The AI model 430 is trained to generate an output predicting a signal quality for one or more networks from a plurality of networks. For example, the AI model 430 may process network data from the network data module 440 (see below) to predict that a particular network will have a high signal quality while the mobile device is connected to that network and/or may select the network from a plurality of networks (including TNs and NTNs) providing network coverage at the geographic location of the mobile device. Continuing with the same example, the predicted signal quality can be based on least one of a subscription level of a user associated with the mobile device (e.g., the particular subscription to a network that the user purchased from a network provider), an amount of data to be transferred by the mobile device over the network, the geographic area where the mobile device is located, an antenna signal strength associated with the mobile device (e.g., the range of an antenna onboard the mobile device, as reported by the mobile device), or a previous connection quality associated with the network (e.g., a signal quality determined for a previous communication link between the mobile device or another mobile device and the network). In some implementations, the AI model 430 receives data upon which its predictions are based from one or more of the modules of the network selection module 308 to generate a predicted signal quality for one or more networks.

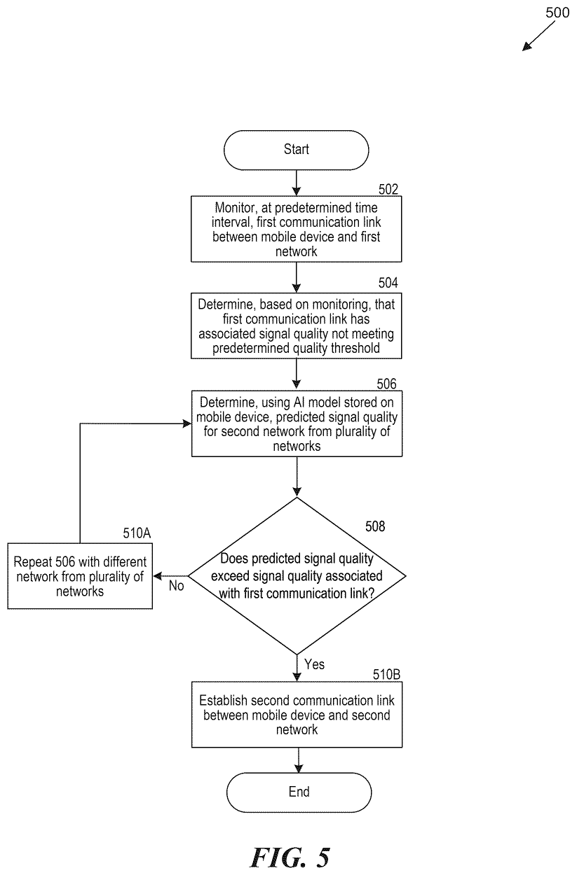

The network selection module 308 can use the output of the AI model 430 output to assign different networks to automatically connect to a new network when that new network has a predicted signal quality exceeding the signal quality associated with a first network to which the mobile device is presently connected. A method of connecting the mobile device to a new network when a first network has an associated signal quality that does not meet a predetermined quality threshold is described in more detail in relation to FIG. 5 below.

### Network Data Module

The network data module 440 is configured and/or programmed to receive network data, such as timing advance values, site coverage/RF signal data (e.g., Reference Signal Received Power (RSRP) data, Reference Signal Received Quality (RSRQ) data), channel quality indicator (CQI) values, capacity on site (configured bandwidth, used bandwidth, etc.), number of users, gain, lead time, and so on.

### Method Flowchart

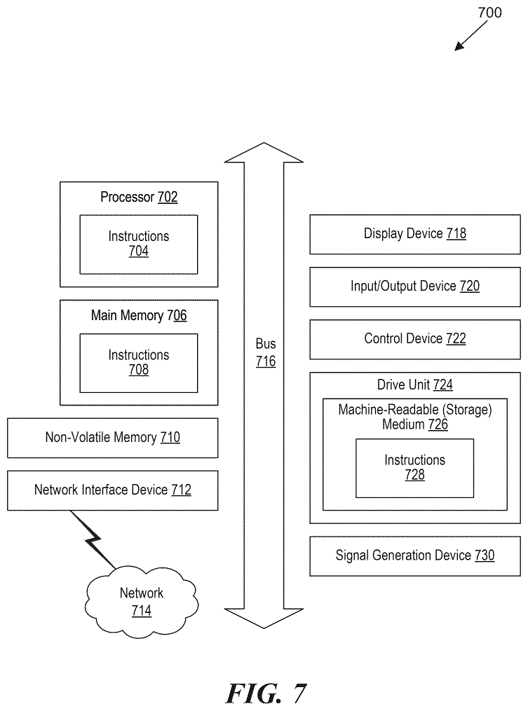

FIG. 5 is a method flowchart illustrating an example method 500 of establishing a communication link between a mobile device and a network, in accordance with some implementations of the present technology. In some implementations, the method 500 is performed by components of the example computer system illustrated and described in more detail in relation to FIG. 7 below and/or the network selection module 308 illustrated and described in more detail in relation to FIG. 3 above. Likewise, implementations can include different and/or additional operations or can perform the operations in different orders.

At 502, a first communication link between a mobile device and a first network is monitored at a predetermined time interval. In some implementations, the first communication link is the same as or generally similar to the communication links 114, 314 described in relation to FIGS. 1 and 3 above. Likewise, the mobile device and first network can be the same as or generally similar to the mobile devices 104-1, 104-2, 304, and networks 100, 310 described in relation to FIGS. 1 and 3 above, respectively. The predetermined time interval is a duration of time between instances of monitoring the communication link, the duration being predetermined based on one or more factors.

In some implementations, the predetermined time interval is based on a frequency of changing network conditions of the mobile device. A changing network condition can be a change in the environment and/or operation of the mobile device that can affect the quality of and/or the desired quality for communication links involving the mobile device, such as a change in location of the mobile device or a change in type/amount of data being sent and/or received by the mobile device. When network conditions are not changing or are changing infrequently, it becomes inefficient to monitor the communication link at frequent time intervals, as the result of the monitoring is likely to be the same or similar with each monitoring action and therefore will provide little useful information. Thus, basing the predetermined time interval on the frequency with which network conditions are changing enables more frequent monitoring when monitoring is more likely to be productive (e.g., during periods of frequent changes in network conditions). Furthermore, because monitoring the communications link (e.g., via a network selection module 308 of the mobile device) consumes computational and battery resources of the mobile device, decreasing the frequency of monitoring when the frequency of changing network conditions is low enables these resources to be conserved without substantially reducing the information obtained via the monitoring.

Additionally or alternatively, the predetermined time interval can be based on a disruption in network connectivity of the mobile device. For example, a disruption in network connectivity can be a loss of connection to the first network, failures in the connection (e.g., packet loss, buffering), and/or other similar disruptions. Disruptions in network connectivity can indicate that the current network connection of the mobile device is unreliable and/or that switching to a different network would improve connection quality. Thus, decreasing the predetermined time interval to result in more frequent monitoring when disruptions in network connectivity are present can help to resolve these connectivity issues more quickly by switching the connection of the mobile device to another network, as described in more detail below.

Additionally or alternatively, the predetermined time interval can also be based on a setting of the mobile device limiting mobile device resource usage. For example, the setting can be a setting which deactivates certain features of the mobile device and/or otherwise limits the operation of the mobile device, such as a “do not disturb” setting limiting notifications, a low battery setting limiting screen brightness and/or processor usage, or another setting where a user of the mobile device expressly limits the monitoring frequency. Activation of one or more of these settings can indicate that the user of the mobile device wishes to conserve the device's resources and/or that the device is unlikely to require a robust network connection while the setting is active. Thus, the likelihood is increased that the predetermined time interval can be lengthened and resources of the mobile device can be conserved without failing to record impactful changes in the connection link quality.

In 504, a determination is made, based on the monitoring of 502, that the first communication link has an associated signal quality that does not meet (e.g., has a quality below that of) a predetermined quality threshold. The associated signal quality is a representation of the ability of the communication link to reliably transmit signals between the mobile device and the first network and can be based on factors such as speed of data transmission, availability of signal from the network, strength of/geographic area covered by the signal from the network, and the like. The predetermined quality threshold is a representation of signal quality that is determined (e.g., by a user of the mobile device or a provider of the mobile device/network) to signify an acceptable level of signal quality for the communication link. For signal qualities below the predetermined quality threshold, the first communication link can be unreliable and the user experience of using the mobile device while connected to the first network can be unsatisfactory due to low speeds, connectivity disruptions, and the like.

In 506, a predicted signal quality for a second network from a plurality of networks is determined using an AI model stored on the mobile device. The predicted signal quality is a representation of a predicted quality of a communication link between the mobile device and the second network, where quality includes factors such as speed of data transmission, availability of signal of the second network, strength of/geographic area covered by the signal of the second network, and the like. The AI model is stored on the mobile device rather than a remote computing device to enable the mobile device to access an output of the AI model even when network connectivity is lost or otherwise unreliable, as the AI model can be executed using one or more processors of the mobile device itself. In some implementations, the AI model includes some or all of the features described in relation to the AI model 630 of FIG. 6 and/or is trained to generate an output indicating a predicted signal quality based on one or more factors related to the mobile device and/or the second network. For example, the predicted signal quality can be based on at least one of a subscription level of a user associated with the mobile device (e.g., the particular subscription to a network that the user purchased from a network provider), an amount of data to be transferred by the mobile device, a geographic location of the mobile device, an antenna signal strength associated with the mobile device (e.g., the range of an antenna onboard the mobile device, as reported by the mobile device), or a previous connection quality associated with the second network (e.g., a signal quality determined as in 404 for a previous communication link between the mobile device or another mobile device and the second communication network).

In some implementations, the plurality of networks is a list of networks including TNs and NTNs with available network connections at the geographic location of the mobile device, and/or are networks which the user is authorized to access based on a subscription purchased from a network provider (e.g., networks included in a data roaming agreement with the network provider). In implementations where the second network is an NTN, the predicted signal quality may be based on a satellite rotation schedule stored on the mobile device and associated with the NTN and/or a number of satellites associated with the NTN. The satellite rotation schedule can indicate the positioning of one or more satellites used as NANs for the NTN in orbit around Earth, which can indicate the availability and/or reliability of the NTN in a certain geographical location on Earth. For example, the satellite rotation schedule may be obtained by the mobile device via a push notification indicating a change in the rotation schedule (e.g., indicating that a satellite used in the NTN has been added, removed, or is damaged/temporarily inactive) or by monitoring (e.g., via a network selection module 308) a server containing and/or publishing the satellite rotation schedule for changes in the schedule and downloading the schedule to the mobile device when a change is detected. Likewise, the number of satellites associated with the NTN can indicate the availability/reliability of the NTN, as a larger number of satellites will typically indicate more robust network coverage.

The second network for which the predicted signal quality is determined can be selected from the plurality of networks in different ways, depending on the implementation. For example, a network selection module 308 making the selection can be configured to prefer connecting to network in the following order: 1) a TN for which the user has a subscription, 2) other available TNs, and 3) available NTNs. In such an example, the first network can be a TN and the second network can be an NTN, but the NTN will only be selected in response to a determination that all TNs in the plurality of networks do not meet (e.g., do not have a predicted signal quality equal to or better than) the predetermined quality threshold and/or do not have a predicted signal quality exceeding the signal quality associated with the first communication link. Thus, the network selection module 308 determines the signal quality of an NTN only after exhausting available TNs as options for connecting to improve signal quality. As another example, the second network can be selected based on a communication link between the second network and a second mobile device communicatively coupled to (e.g., transmitting data to and/or receiving data from) the mobile device. The connection between the second network and the second mobile device can indicate that the second network is reliable enough for the second mobile device to operate and communicate with the mobile device and therefore that the second network is a likely candidate for having a predicted signal quality exceeding that associated with the first communication link. Continuing with the same example, the second mobile device may be a peripheral device (e.g., a smart watch, a smart appliance) communicatively coupled to the mobile device from which the network selection module 308 can retrieve the identity of the second network.

In 508, a check as to whether the predicted signal quality exceeds (e.g., is of a higher quality than) the signal quality associated with the first communication link is performed. When the predicted signal quality does not exceed the signal quality associated with the first communication link, connecting to the second network would not improve network connection quality for the mobile device, so the method 500 proceeds to 510A where 506 is repeated using a different network (e.g., a network other than the second network) from the plurality of networks. Repeating the step of determining a predicted signal quality for a network until the predicted signal quality exceeds the signal quality associated with the first communication link allows a network with higher signal quality than the first network to which the mobile device is connected to be identified.

When the predicted signal quality for the second network does exceed the signal quality associated with the first communication link, the method 500 proceeds to 510B where a second communication link between the mobile device and the second network is established. Thus, the mobile device is automatically connected to a network which can provide a more improved signal quality than in comparison to the first network without the user of the mobile device having to manually identify or select the second network. In some implementations, establishing the second communication link includes disconnecting the mobile device from the first network (e.g., disconnecting the first communication link).

### Artificial Intelligence System

FIG. 6 is a block diagram that illustrates an example of an AI system 600 in which at least some operations described herein can be implemented. Example machine learning (ML) models can include the models executed by the network selection module 308. Accordingly, the network selection module 308 can include one or more components of the AI system 600.

As shown in FIG. 6, the AI system 600 can include a set of layers, which conceptually organize elements within an example network topology for the AI system's architecture to implement a particular AI model 630. Generally, an AI model 630 is a computer-executable program implemented by the AI system 600 that analyses data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic and networking. The hardware platform 610 can process amounts of data using one or more servers. The servers can perform backend operations such as matrix calculations, parallel calculations, ML training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources, (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include Intel Math Kernel Library, Nvidia cuDNN, Eigen, and Open BLAS.

The structure layer 604 can include an ML framework 614 and an algorithm 616. The ML framework 614 can be thought of as an interface, library, or tool that allows users to build and deploy the AI model 630. The ML framework 614 can include an open-source library, an application programming interface (API), a gradient-boosting library, an ensemble method, and/or a deep learning toolkit that work with the layers of the AI system facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630. Examples of ML frameworks 614 that can be used in the AI system 600 include TensorFlow, PyTorch, Scikit-Learn, Keras, Cafffe, LightGBM, Random Forest, and Amazon Web Services.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include asset tracking histories with known threat levels, resources with known relevancy scores measuring their relevance to known assets, and logs of physical and digital features with known correspondences and similarities. The user may label the training data based on one or more classes and trains the AI model 630 by inputting the training data to the algorithm 616. The algorithm determines how to label the new data based on the labeled training data. The user can facilitate collection, labeling, and/or input via the ML framework 614. In some instances, the user may convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., service name, asset room location, asset IP address) relate to the categories (e.g., high risk, or low risk of cybersecurity attack). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for ML-based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Said another way, unsupervised learning is used to train the algorithm 616 to find an underlying structure of a set of data, group the data according to similarities, and represent that set of data in a compressed format. The relevancy models, correspondence model, threat detection model, and the LLM fine-tuned on threat detection from tracking histories, can use unsupervised learning to identify patterns in tracking histories, security logs, and multimodal resources (e.g., to identify particular patterns in cybersecurity attacks) and so forth. In some implementations, performance of the relevancy model engine that can use unsupervised learning is improved because it can learn how to fine-tune the model by setting an ideal cut-off score for relevancy rank, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 616 include factor analysis, item response theory, latent profile analysis, and latent class analysis.

The model layer 606 implements the AI model 630 using data from the data layer and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 620 may include one or more hidden layers of nodes between the input and output layers. The model structure 620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's 530 performance during training. For instance, the loss function engine 624 can measure the difference between a predicted output of the AI model 630 and the actual output of the AI model 630 and is used to guide optimization of the AI model 630 during training to minimize the loss function. The loss function may be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents over-and under-fitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constraint the resulting AI model 630 and improves its ability for generalized application. Examples of regularization techniques include lasso (L1) regularization, ridge (L2) regularization, and elastic (L1 and L2 regularization).

The application layer 608 describes how the AI system 600 is used to solve problem or perform tasks. In an example implementation, the application layer 608 can include the LLM, and/or the models for network selection used in the method 500, illustrated in FIG. 5, or the network selection environment 300, illustrated by FIG. 3.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above and any that may be listed in accompanying filing papers are incorporated herein by reference in their entireties, except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A non-transitory, computer-readable storage medium comprising instructions recorded thereon, wherein the instructions, when executed by at least one data processor of a system, cause the system to:
monitor, at a predetermined time interval, a first communication link between a mobile device and a first network;
determine, based on said monitoring, that the first communication link has an associated signal quality that does not meet a predetermined quality threshold;
select, using an AI model stored on a memory of the mobile device, a second network from a plurality of networks, wherein the second network is associated with a predicted signal quality exceeding the signal quality associated with the first communication link; and
based on the selection, establish a second communication link between the mobile device and the second network.

2. The non-transitory, computer-readable storage medium of claim 1, wherein the predetermined time interval is based on a frequency of changing network conditions of the mobile device.

3. The non-transitory, computer-readable storage medium of claim 1, wherein the predetermined time interval is based on a disruption in network connectivity of the mobile device.

4. The non-transitory, computer-readable storage medium of claim 1, wherein the predetermined time interval is based on a setting of the mobile device limiting mobile device resource usage.

5. The non-transitory, computer-readable storage medium of claim 1, wherein the first network is a terrestrial network and the second network is a non-terrestrial network (NTN).

6. The non-transitory, computer-readable storage medium of claim 5, wherein the second network is selected in response to a determination that a third network in the plurality of networks is associated with a predicted signal quality that does not meet the predetermined quality threshold, and wherein the third network is a terrestrial network.

7. The non-transitory, computer-readable storage medium of claim 1, wherein the predicted signal quality is based on at least one of a subscription level of a user associated with the mobile device, an amount of data to be transferred by the mobile device, a geographic location of the mobile device, an antenna signal strength associated with the mobile device, or a previous connection quality associated with the second network.

8. The non-transitory, computer-readable storage medium of claim 1, wherein the second network is a non-terrestrial network (NTN) and the predicted signal quality is based on at least one of a satellite rotation schedule stored on the mobile device and associated with the NTN or a number of satellites associated with the NTN.

9. The non-transitory, computer-readable storage medium of claim 1, wherein the mobile device is a first mobile device, and wherein the second network is selected based on a third communication link between the second network and a second mobile device communicatively coupled to the first mobile device.

10. A system comprising:
at least one hardware processor; and
at least one non-transitory memory storing instructions, which, when executed by the at least one hardware processor, cause the system to:
monitor, at a predetermined time interval, a first communication link between a mobile device and a first network;
determine, based on said monitoring, that the first communication link has an associated signal quality that does not meet a predetermined quality threshold;
select, using an AI model stored on a memory of the mobile device, a second network from a plurality of networks, wherein the second network is associated with a predicted signal quality exceeding the signal quality associated with the first communication link; and
establish a second communication link between the mobile device and the second network.

11. The system of claim 10, wherein the predetermined time interval is based on a frequency of changing network conditions of the mobile device.

12. The system of claim 10, wherein the predetermined time interval is based on a disruption in network connectivity of the mobile device.

13. The system of claim 10, wherein the predetermined time interval is based on a setting of the mobile device limiting mobile device resource usage.

14. The system of claim 10, wherein the first network is a terrestrial network and the second network is a non-terrestrial network (NTN).

15. The system of claim 14, wherein the second network is selected in response to a determination that a third network in the plurality of networks is associated with a predicted signal quality that does not meet the predetermined quality threshold, and wherein the third network is a terrestrial network.

16. The system of claim 10, wherein the predicted signal quality is based on at least one of a subscription level of a user associated with the mobile device, an amount of data to be transferred by the mobile device, a geographic location of the mobile device, an antenna signal strength associated with the mobile device, or a previous connection quality associated with the second network.

17. The system of claim 10, wherein the second network is a non-terrestrial network (NTN) and the predicted signal quality is based on at least one of a satellite rotation schedule stored on the mobile device and associated with the NTN or a number of satellites associated with the NTN.

18. A method comprising:
monitoring, by a mobile device at a predetermined time interval, a first communication link between the mobile device and a first network;
determining, by the mobile device based on said monitoring, that the first communication link has an associated signal quality that does not meet a predetermined quality threshold;
selecting, by the mobile device using an AI model stored on a memory of the mobile device, a second network from a plurality of networks, wherein the second network is associated with a predicted signal quality exceeding the signal quality associated with the first communication link; and
based on the selection, establishing, by the mobile device, a second communication link between the mobile device and the second network.

19. The method of claim 18, wherein the first network is a terrestrial network and the second network is a non-terrestrial network (NTN).

20. The method of claim 19, wherein the second network is selected in response to a determination that a third network in the plurality of networks is associated with a predicted signal quality that does not meet the predetermined quality threshold, wherein the third network is a terrestrial network.
